(19) United States
(12) Patent Application Publication
(10) Pub. No.: US 2008/0058082 A1
(43) Pub. Date: Mar. 6, 2008

(54) Gaming machine which determines award based on combination of symbols located on movement path of moving character and playing method for gaming machine

(76) Inventor: Katsuhiro Kido, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/889,224

(22) Filed: Aug. 9, 2007

(30) Foreign Application Priority Data
Aug. 10, 2006 (JP) 2006-218860

(51) Int. Cl. A63F 13/00; G07F 17/34

(52) U.S. Cl. 463/20

(57) ABSTRACT

A gaming machine includes a display and a game controller. The display displays thereon a symbol display area in which one of symbols is arranged, and a symbol display frame made up of symbol display areas. When executing a game, the game controller performs: displaying, at an outside of the symbol display frame, a character that moves on a movement path having a symbol display area as a unit basis thereof; moving the character displayed at the outside of the symbol display frame, along the movement path over the symbol display areas; and determining an award given to a player based on a combination of symbols that are located on the movement path of the moving character.

### CROSS REFERENCE TO RELATED APPLICATION

This application is based upon and claims the benefit of priority from the prior Japanese Patent Applications No. 2006-218860, filed on Aug. 10, 2006, the entire contents of which are incorporated herein by reference.

### BACKGROUND OF THE INVENTION

1. Field of the Invention

The present invention relates to a gaming machine that gives an award based on a combination of arranged symbols and also relates to a playing method for the gaming machine. More particularly, the present invention relates to a gaming machine that displays a moving character over arranged symbols and determines an award given to a player based on a combination of symbols located on a movement path of the moving character, and also relates to a playing method for the gaming machine.

2. Description of Related Art

Conventionally, in a general gaming machine, symbol display areas are arranged in a matrix. In each of the symbol display areas, one symbol included in a column of several symbols is placed. In such a general gaming machine, an award given to a player is determined based on a combination of symbols placed in, among the symbol display areas arranged in the matrix, symbol display areas located on a certain activated pay line of linear shape. However, determining an award based on a combination of symbols placed on a linear activated pay line is too common a manner to be effective in improving pleasure of a player.

Accordingly, a gaming machine that adds variation to the activated pay line and a gaming machine that does not adopt an idea of the activated pay line have now been developed. For example, gaming machines disclosed in U.S. Pat. No. 6,093,102 and in U.S. Pat. No. 6,960,133 are known as a gaming machine that determines an award not only by a combination of symbols placed on a linear activated pay line. In the gaming machines disclosed in the above-mentioned documents, when determining an award, variation is added to the activated pay line or no idea of the activated pay line is adopted. However, presenting a game result to a player by means of symbol display areas arranged in a matrix is eventually equal to determining an award based on a combination of symbols placed on a linear activated pay line. Accordingly, there is no effectiveness in terms of improving pleasure of a player.

### SUMMARY OF THE INVENTION

An object of the present invention is to provide a gaming machine that notifies a game result in a manner different from conventional manners and visually improves pleasure of a player, and also to provide a playing method for the gaming machine.

According to a first aspect of the present invention, there is provided a gaming machine comprising a display and a game controller. The display displays thereon a symbol display area in which one of a plurality of symbols is arranged, and a symbol display frame made up of a plurality of symbol display areas. When executing a game, the game controller performs: displaying, at an outside of the symbol display frame, a character that moves on a movement path having a symbol display area as a unit basis thereof; moving the character displayed at the outside of the symbol display frame, along the movement path over the symbol display areas; and determining an award given to a player based on a combination of symbols that are located on the movement path of the moving character.

According to a second aspect of the present invention, there is provided a playing method for a gaming machine comprising a symbol display frame that is displayed on a display and made up of a plurality of symbol display areas in each of which one of a plurality of symbols is arranged. In the playing method, when executing a game, the game controller performs: displaying, at an outside of the symbol display frame, a character that moves on a movement path having a symbol display area as a unit basis thereof; moving the character displayed at the outside of the symbol display frame, along the movement path; and determining an award given to a player based on a combination of symbols that are located on the movement path of the moving character.

In the first and second aspects, a symbol display frame made up of a plurality of symbol display areas is displayed on a display. When symbols are arranged in the respective symbol display areas, a character is displayed at an outside of the symbol display frame. The character is moved within the symbol display frame, along a movement path having a symbol display area as a unit basis thereof. An award given to a player is determined based on a combination of symbols located on the movement path of the character. Therefore, in the gaming machine and playing method for the gaming machine according to the present invention, an award is determined depending not on a linear activated pay line but on a combination of symbols located on the movement path of the character. As a result, a player can enjoy longer-term expectation for an award, because he/she cannot know which combination of symbols is accomplished until a movement of the character ends. In addition, the character is moved within the symbol display frame. This provides a wider variety of display modes on the display. Accordingly, in the symbol display frame, a variety of display modes are presented until a player is notified of a game result. Thus, there can be provided a gaming machine and a playing method for a gaming machine that visually present a great pleasure.

### BRIEF DESCRIPTION OF THE DRAWINGS

Other and further objects, features and advantages of the invention will appear more fully from the following description taken in connection with the accompanying drawings in which:

FIG. 1 is an explanatory view showing a display mode of a lower display while weight character images are moving;

FIG. 2 is an explanatory view showing a display mode of the lower display before the weight character images move;

FIG. 3 is an explanatory view showing a display mode of the lower display after the weight character images move;

FIG. 4 is a front view showing a symbol display section according to an embodiment of the present invention;

FIG. 5 is an explanatory view showing columns of symbols in respective reel display areas;

FIG. 6 is a payout table showing awards that are paid out to a player based on combinations of symbols;

FIG. 7 is a perspective view showing an appearance of a gaming machine according to a first embodiment;

FIG. 8 is a block diagram showing a control system of the gaming machine according to the first embodiment;

FIG. 9 is a flowchart showing a main control processing program;

FIG. 10 is a flowchart showing a main game processing program;

FIG. 11 is a flowchart showing a character display processing program;

FIG. 12 is an explanatory view concerning a character movement amount determination table;

FIG. 13 is a perspective view showing an appearance of a gaming machine according to a second embodiment; and

FIG. 14 is a block diagram showing a control system of the gaming machine according to the second embodiment.

### DESCRIPTION OF THE PREFERRED EMBODIMENTS

In the following, some preferred embodiments of the present invention will be described with reference to the accompanying drawings.

### First Embodiment

A first embodiment of the present invention will be described in detail with reference to the accompanying drawings. In the first embodiment, the present invention is applied to a so-called video gaming machine. Here, a video gaming machine is a gaming machine that has an image display device such as a liquid crystal display and presents a game by displaying various symbol images on the image display device.

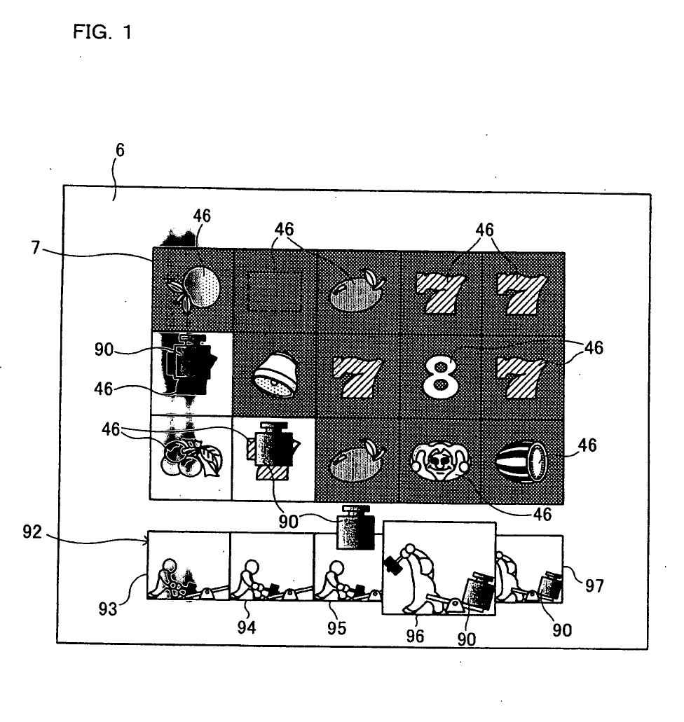

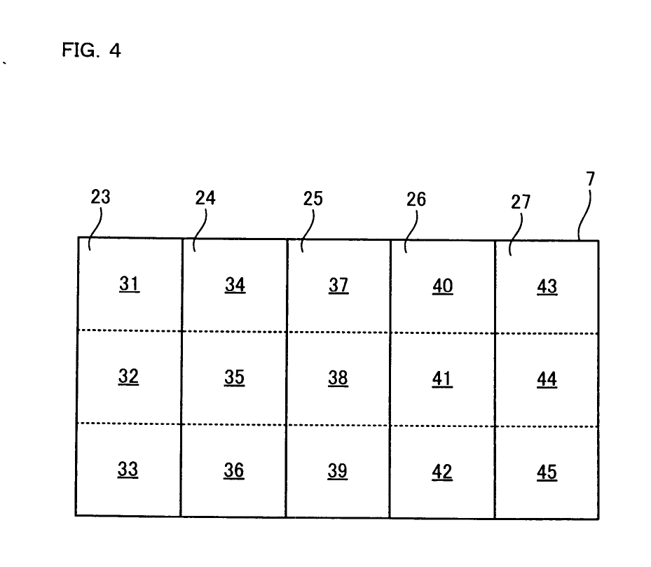

First, a game played in a gaming machine 1 according to the first embodiment will be generally described with reference to FIGS. 1 to 3. In the gaming machine 1 according to the first embodiment, when executing a game, a symbol display section 7 made up of fifteen symbol display areas 31 to 45 is displayed on a lower display 6 (see FIG. 4). The fifteen symbol display areas 31 to 45 are arranged in a matrix with five columns and three rows. As shown in FIG. 4, a column of three symbol display areas constitute a reel display area. For example, the symbol display areas 37, 38, and 39, which are located at a widthwise center of the symbol display section 7, constitute a reel display area 25. That is, the symbol display section 7 is made up of five reel display areas 23 to 27. In addition, as shown in FIGS. 1 to 3, an animation display section 92 is displayed below the symbol display section 7. The animation display section 92 is made up of five animation display areas 93 to 97 that are arranged side by side in a row. The five animation display areas 93 to 97 correspond to the reel display areas 23 to 27 disposed directly overhead, respectively (see FIG. 4). For example, the animation display area 97 located rightmost in the animation display section 92 corresponds to the reel display area 27 located rightmost in the symbol display section 7.

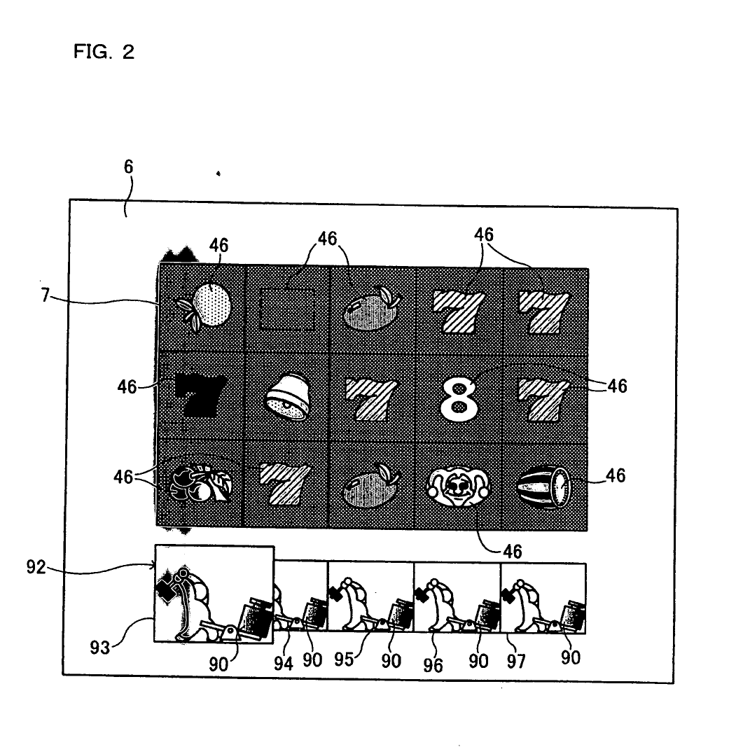

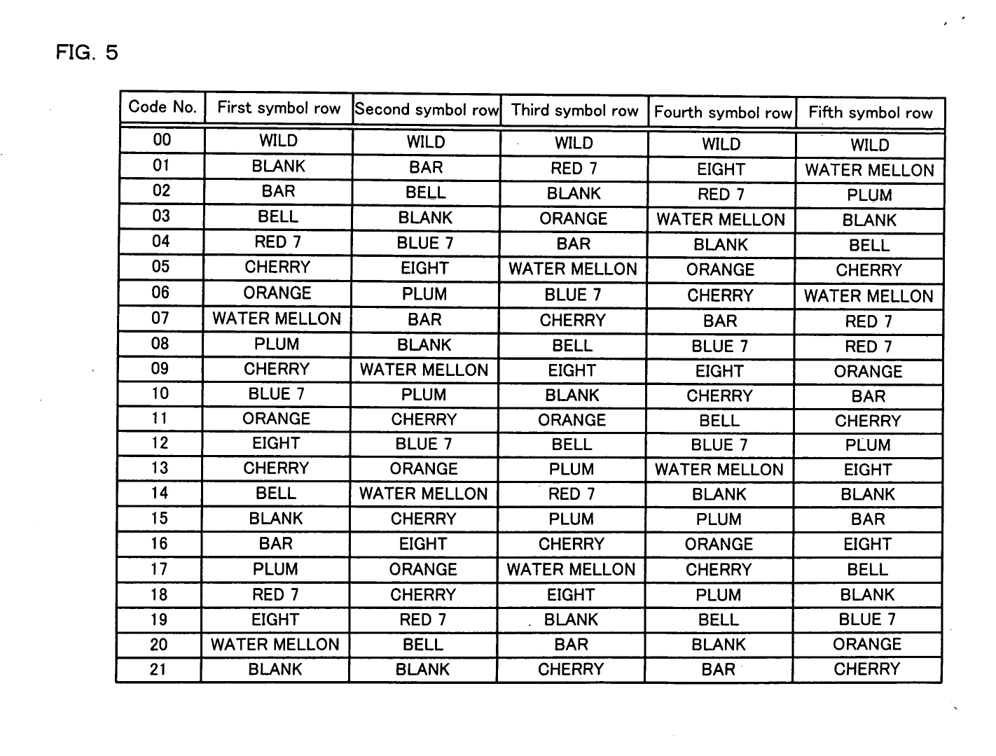

As a game starts in the gaming machine 1, symbols 46 arranged in the respective symbol display areas 31 to 45 of the symbol display section 7 are determined. In the gaming machine 1, one column of symbols is associated with one reel display area. The column of symbols is made up of eleven kinds of symbols, namely, a “WILD” symbol, a “RED 7” symbol, a “BLUE 7” symbol, a “BAR” symbol, an “EIGHT” symbol, a “BELL” symbol, a “WATER MELLON” symbol, a “PLUM” symbol, an “ORANGE” symbol, a “CHERRY” symbol, and a “BLANK” symbol (see FIG. 5). Symbols 46 which will be arranged in symbol display areas included in each of the reel display areas 23 to 27 are determined based on a column of symbols associated with this reel display area (see FIG. 5). For example, for the symbol display areas 37 to 39 that are included in the reel display area 25, symbols 46 which will be displayed therein are determined based on a third column of symbols shown in FIG. 5. When symbols 46 for the respective symbol display areas 31 to 45 are determined in this way, fifteen symbols 46 thus determined are displayed in the symbol display section 7. At this time, as shown in FIG. 2, a background color of the symbol display areas 31 to 45 is black.

At this time, an image is displayed in each of the animation display areas 93 to 97 of the animation display section 92. The image shows that “a person character swings up a hammer toward one end of a seesaw so that a weight character image 90 placed on the other end of the seesaw is ready to launch up” (see FIG. 2). At this point of time, as shown in FIG. 2, the animation display area 93 located leftmost in the animation display section 92 is enlarged as compared with the other animation display areas 94 to 97.

Then, in the animation display section 92, an animation is displayed in the animation display areas sequentially from the leftmost animation display area 93 to right side ones, as shown in FIG. 1. The animation shows that “a person character swings down a hammer so that a weight character image 90 is launching up”. When an animation display in one animation display area is completed, then an animation display area located right next to the one animation display area is enlarged. In the enlarged animation display area, the above-described animation is displayed. When an animation display in one animation display area is completed, that is, when a person character has swung down a hammer so that a weight character image 90 launches up, the weight character image 90 moves toward an upper end of a reel display area that is located above this animation display area. For example, when an animation display in the animation display area 95 is completed as shown in FIG. 1, the weight character image 90 moves from the animation display area 95 toward an upper end of the reel display area 25, that is, the symbol display area 37 (see FIG. 1).

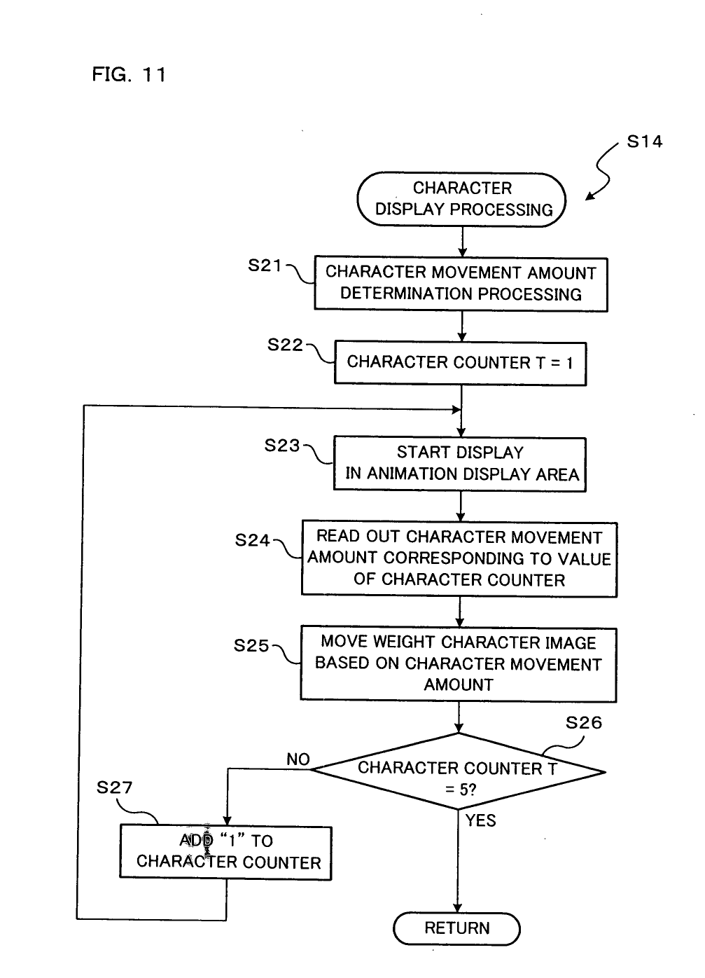

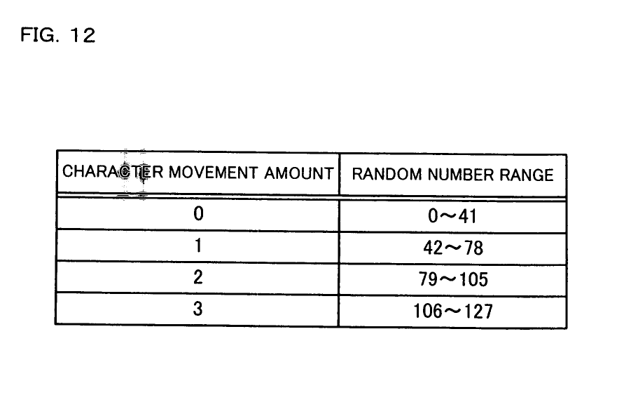

Here, a movement of the weight character image 90 is based on a character movement amount determined by a character movement amount determination processing S21 which will be described later (see FIGS. 11 and 12). As the character movement amount, values of “0” to “3” are set. Each of the values indicates at which symbol display area of one reel display area the weight character image 90 moving from a lower side will stop. In the first embodiment, each of the values indicates the position of a symbol display area as counted from the downmost ones in the reel display area over which the weight character image 90 moving from a lower side passes.

As shown in FIG. 1, during a movement of the weight character image 90 based on the character movement amount, when the weight character image 90 reaches a certain symbol display area, a background color of this symbol display area is changed from “black” to “white”.

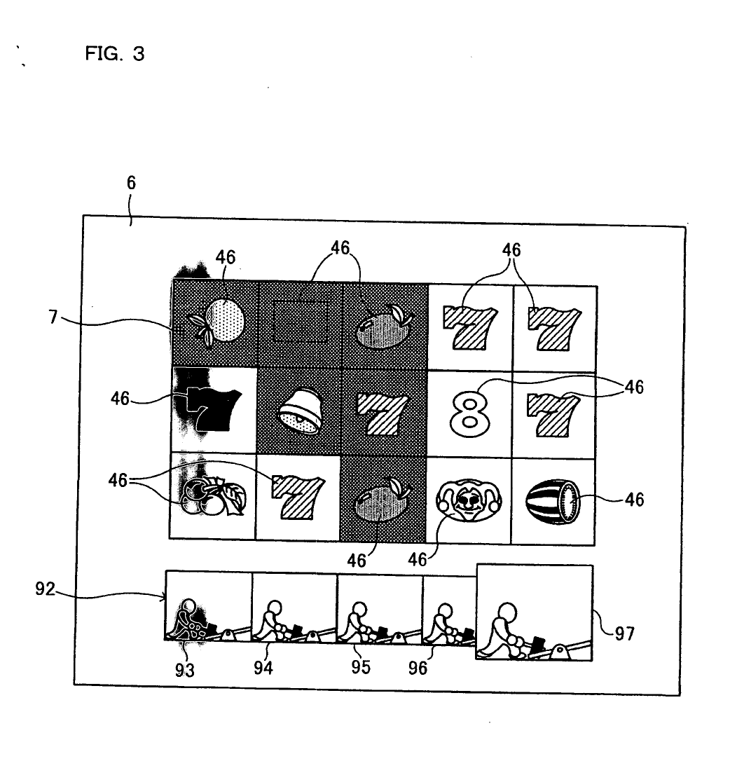

Like this, animations are sequentially displayed in an order from the animation display area 93 to the animation display area 97, and then movements of the weight character images 90 toward the respective reel display areas 23 to 27 are completed (see FIG. 3). Thus, in this gaming machine, an award given to a player is determined based on a combination of symbols 46 placed in the symbol display areas on which the weight character images 90 have moved. Here, a background color of the symbol display areas on which the weight character images 90 have moved is changed to “white”, while a background color of the symbol display areas on which no weight character image 90 has moved remains “black”. Accordingly, by seeing symbol display areas with “white” backgrounds, a player knows a combination of symbols accomplished in the current game and thereby understands an award.

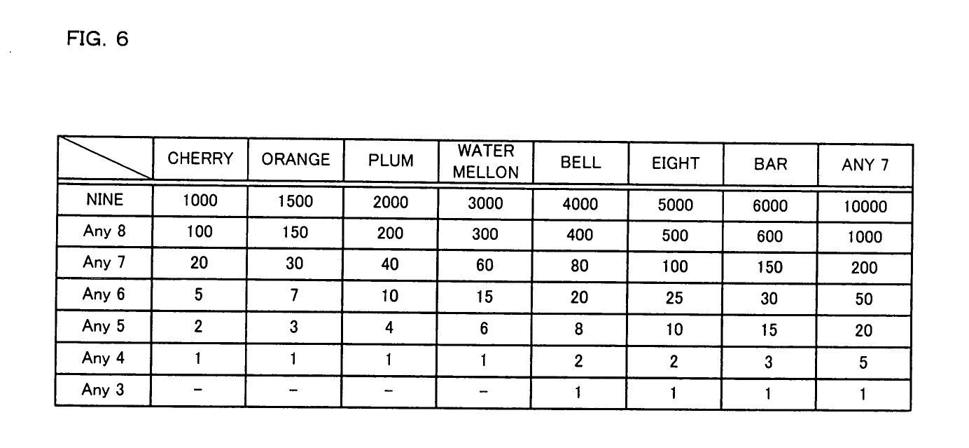

Here, in the gaming machine 1 according to the first embodiment, an award differs depending on the number of the same kind of symbols 46 among symbols 46 that are placed in the symbol display areas located on movement paths of the weight character images 90 (see FIG. 6). That is, how symbols 46 are arranged in the symbol display section 7 shown in FIG. 3 has no relation to winning an award. More specifically, as shown in FIG. 6, a win is made when an accomplished combination of symbols 46, which are placed in symbol display areas whose background color has been changed to “white” because the weight character images 90 moved thereon, includes not less than a predetermined number of symbols of the same kind. Then, an award corresponding to the kind and the number of the symbols is paid out. Among the eleven kinds of symbols 46 mentioned above, the “WILD” symbol is a symbol counted as any of the other ten kinds of symbols 46. Moreover, in the first embodiment, the “RED 7” symbol and the “BLUE 7” symbol are treated as the same kind of symbols 46. However, they may be counted individually as symbols of different kinds.

Here, taking a case shown in FIG. 3 as an example, a specific description will be given to determination of an award. In the case shown in FIG. 3, symbols 46 located on movement paths of the weight character images 90 (which mean symbols 46 placed in symbol display areas whose background color has been changed to “white” because the weight character images 90 moved thereon) are a total of nine symbols 46, namely, four “RED 7” symbols, one “WILD” symbol, one “BLUE 7” symbol, one “EIGHT” symbol, one “WATER MELLON” symbol, and one “CHERRY” symbol. As described above, an award is determined based on a combination of symbols 46 which is defined by how many of symbols 46 located on movement paths of the weight character images 90 are of the same kind (see FIG. 6). That is, in the case shown in FIG. 3, a total number of “RED 7” and “BLUE 7” symbols is five and in addition there is a “WILD” symbol, an “Any 6” combination of “ANY 7” is made. Therefore, in the case shown in FIG. 3, a credit of “50” is awarded to a player. Here, in this case, if the “WILD” symbol is any one of the “BAR” symbol, the “EIGHT” symbol, the “BELL” symbol, the “WATER MELLON” symbol, the “PLUM” symbol, the “ORANGE” symbol, the “CHERRY” symbol, and the “BLANK” symbol, an “Any 5” combination of “ANY 7” is made and therefore a credit of “20” is given.

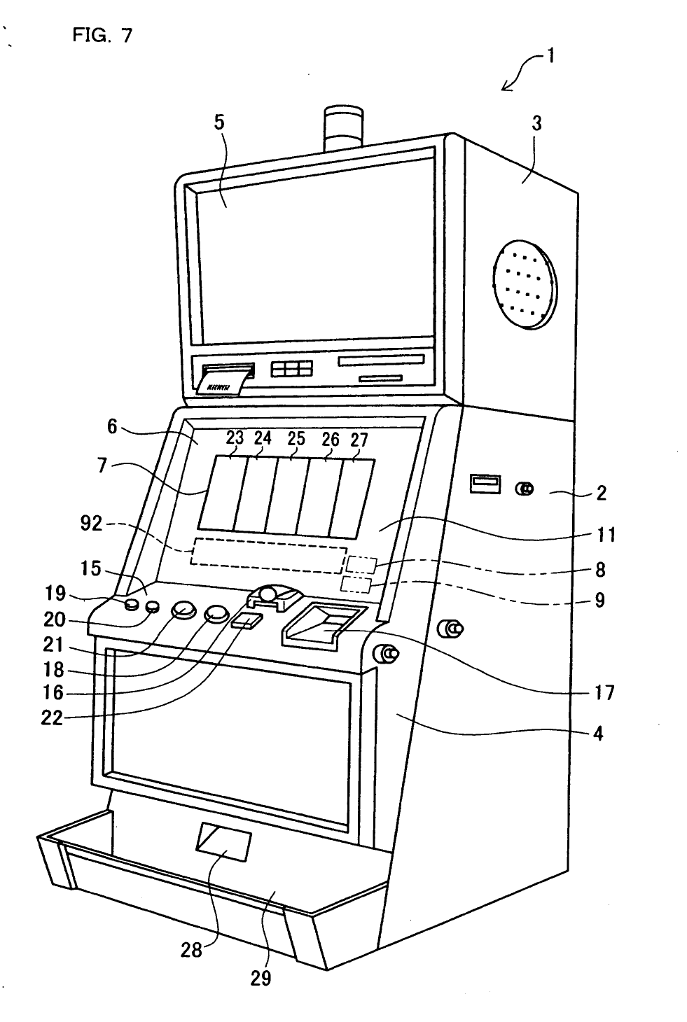

Next, a general construction of the gaming machine 1 according to the first embodiment will be described with reference to the accompanying drawings. FIG. 7 is a perspective view showing an appearance of the gaming machine 1 according to the first embodiment.

The gaming machine 1 according to the first embodiment includes a cabinet 2, a top box 3 placed on an upper side of the cabinet 2, and a main door 4 provided on a front face of the cabinet 2. An upper display 5 is provided on a front face of the top box 3. Here, the upper display 5 is made up of a known liquid crystal display. A playing manner, a payout table, and the like are displayed on the upper display 5.

On the other hand, a lower display 6 is provided on a front face of the main door 4. Here, the lower display 6 is made up of a known liquid crystal display. The lower display 6 has a symbol display section 7 including five reel display areas 23 to 27. Each of the reel display areas 23 to 27 is made up of three symbol display areas (see FIG. 4). That is, as shown in FIG. 4, the symbol display section 7 has fifteen symbol display areas, and one symbol 46 is associated with each of the fifteen symbol display areas. Symbols 46 displayed in three symbol display areas that constitute each of the reel display areas 23 to 27 are determined based on each of first to fifth columns of symbols (see FIG. 5). The first to fifth columns of symbols are associated with the reel display areas 23 to 27, respectively.

As described above, the animation display section 92 is provided below the symbol display section 7. The animation display section 92 is made up of five animation display areas 93 to 97. The animation display areas 93 to 97 are associated with the reel display areas 23 to 27 disposed directly overhead, respectively. During execution of a game, an animation showing a weight character image 90 being launching up is displayed in each of the animation display areas. Each of the animation display areas works as a starting point of a movement of the weight character image 90 toward each of the reel display areas.

A touch panel 11 is provided on a front face of the lower display 6. A player is able to input various commands by operating the touch panel 11. In addition, the lower display 6 has a credit value indicator 8 and a payout number indicator 9. In the credit value indicator 8, a credit value currently held by a player is indicated. In the payout number indicator 9, an amount of an award which will be given on condition that a predetermined winning combination of symbols is stopped in the symbol display section 7 is indicated as a payout number.

A control panel 15, a coin reception slot 16, and a bill insertion slot 17 are provided below the lower display 6. The control panel 15 has buttons through which a player inputs command for making progress on a game. The coin reception slot 16 receives a coin, which is a game medium, into the cabinet 2. A start button 18, a change button 19, a CASHOUT button 20, a 1-BET button 21, and a MAX-BET button 22 are provided on the control panel 15. The start button 18 is an operation unit used for inputting a command to start a game in the gaming machine 1. The change button 19 is an operation unit used in asking a staff of a game arcade for an exchange. The CASHOUT button 20 is an operation unit used for inputting a command to pay out a number of coins, which is equivalent to a credit value held by a player, through a coin payout opening 28 into a coin tray 29, or a command to pay out a number of coins, which is equivalent to a credit value held by a player, in the form of a barcoded ticket. Here, in the first embodiment, one credit is equivalent to one coin. The 1-BET button 21 is an operation unit used for receiving a command to bet on a game one credit among all credits held by a player. The MAX-BET button 22 is an operation unit used for receiving a command to bet on a game a maximum credit value bettable on one game, among all credits held by a player. In the first embodiment, the maximum credit value bettable on one game is 50 credits. It may be possible to additionally provide various BET buttons such as a 3-BET button.

In the gaming machine 1 according to the first embodiment, a coin, a bill, or valuable electronic information (credit) equivalent to them are used as a game medium. However, a game medium applicable to the present invention is not limited thereto. For example, a medal, a token, electronic money, a ticket, and the like may be used as a game medium.

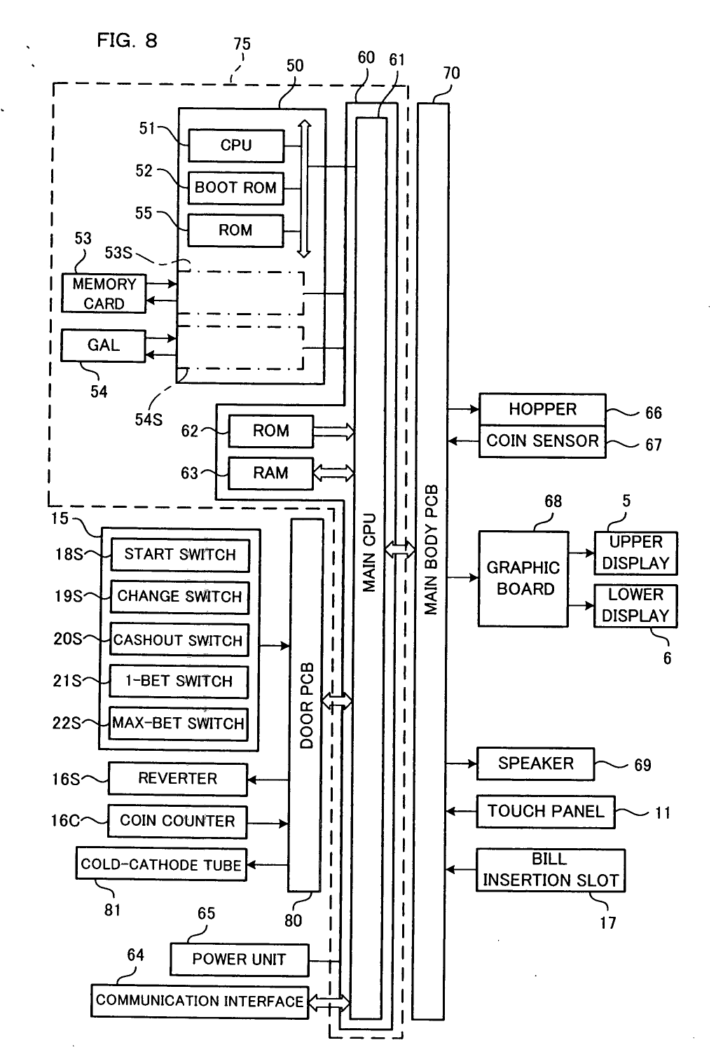

Next, a configuration of a control system of the gaming machine 1 according to the first embodiment will be described with reference to FIG. 8. FIG. 8 is a block diagram schematically showing a control system of the gaming machine 1 according to the first embodiment.

As shown in FIG. 8, a control system of the gaming machine 1 is basically made up of a mother board 60 and a gaming board 50. That is, the mother board 60 and the gaming board 50 constitute a game controller 75 that performs controllings for a game in the gaming machine 1.

The gaming board 50 will be described first. The gaming board 50 includes a CPU 51, a ROM 55, a boot ROM 52, a card slot 53S, and an IC socket 54S. The CPU 51, the ROM 55, and the boot ROM 52 are connected to each other via an internal bus. The card slot 53S is for a memory card 53. The IC socket 54S is for a GAL (General Array Logic) 54.

The memory card 53 is a memory medium formed of a non-volatile memory. A game program and a game system program (hereinafter referred to as a game program and the like) are stored in the memory card 53. The game program recorded on the memory card 53 includes a lottery program. The lottery program is a program for determining symbols 46 which will be displayed in the symbol display areas 31 to 45 shown in FIG. 4. The memory card 53 includes a symbol lottery table used for selecting symbols 46 which will be displayed in the symbol display areas 31 to 45. The symbol lottery table is a table of correspondence between each kind of symbol 46 and a predetermined random number range. Here, a description will be given to determination of symbols 46 which will be displayed in the respective symbol display areas based on the symbol lottery table. First, based on the symbol lottery table, symbols 46 for certain symbol display areas (e.g., symbol display areas 32, 35, 38, 41, and 44 located in middle parts of the respective reel display areas 23 to 27 shown in FIG. 4) are selected and associated respectively. Here, as shown in FIG. 5, code numbers are assigned to the symbols included in each of the first to fifth columns of symbols. Therefore, determined are code numbers corresponding to symbols 46 that are associated with the symbol display areas located in the middle parts of the respective reel display areas. As code numbers for the symbol display areas located in the middle parts of the respective reel display areas are determined, then code numbers for the symbol display areas located in upper and lower parts of the respective reel display areas are determined to be code numbers next to the code numbers for the middle parts. As a consequence, symbols 46 associated with the symbol display areas located in the upper and lower parts of the respective reel display areas are also determined based on the code numbers determined. The symbol lottery table may be, for example, a table of correspondence between a predetermined random number range and an award given to a player. In such a case, first, an award given to a player is selected based on the symbol lottery table, and then a main CPU 61 selects a combination of symbols 46 that satisfies the award thus determined.

Next, the mother board 60 will be described. The mother board 60 is formed using a general-purpose mother board on the market, that is, a printed wiring board mounted with basic components of a personal computer. The mother board 60 has a main CPU 61, a ROM 62, a RAM 63, and a communication interface 64.

The ROM 62 is a memory device such as a flash memory. Permanent data including for example a program such as a BIOS, which is executed by the main CPU 61, are stored in the ROM 62. When the main CPU 61 executes the BIOS, predetermined peripheral units are subjected to an initialization process, and the game program and the like stored in the memory card 53 start to be captured via the gaming board 50.

Data and programs that are used when the main CPU 61 operates are stored in the RAM 63. In addition, the RAM 63 can store therein various programs such as an authentication program, the game program and the like which are read out through the gaming board 50, and various information such as a credit value currently held by a player.

The communication interface 64 is a communication device that communicates through a communication line with a server and the like placed in a game arcade.

A main body PCB 70 and a door PCB 80 which will be described later are respectively connected to the mother board 60 via USBs. The power unit 65 is also connected to the mother board 60. When power is supplied from the power unit 65 to the mother board 60, the main CPU 61 of the mother board 60 is started, and further power is supplied through the PCI bus to the gaming board 50 so that the CPU 51 is started.

A hopper 66, a coin sensor 67, a graphic board 68, a speaker 69, a touch panel 11, a bill insertion slot 17, and the like are connected to the main body PCB 70.

The graphic board 68 controls image display on the upper display 5 and the lower display 6, based on a control signal from the main CPU 61. For example, during a game, the graphic board 68 performs general display controllings such as displaying symbols 46 in the symbol display section 7 of the lower display 6, displaying an animation in the animation display section 92, moving a weight character image 90, and the like. The graphic board 68 has a frame memory with two planes for displaying the symbol display section 7 on the lower display 6. Stored on one plane (hereinafter referred to as a first plane) of the frame memory are fifteen symbols 46 associated with the symbol display areas 31 to 45 which constitute the symbol display section 7. Stored on the other plane (hereinafter referred to as a second plane) of the frame memory are image data including a moving weight character image 90, animation images in the respective animation display areas 93 to 97, background color images for the symbol display areas 31 to 45, and the like. In the graphic board 68, image data stored in the first and second planes of the frame memory are composed and written into a VRAM. In composing the image data stored in the first and second planes of the frame memory, the image data stored in the second plane take priority. Displaying on the lower display 6 during execution of a game is based on composition data thus written into the VRAM.

The control panel 15, a reverter 16S, a coin counter 16C, and a cold-cathode tube 81 are connected to the door PCB 80. The control panel 15 includes a start switch 18S corresponding to the start button 18, a change switch 19S corresponding to the change button 19, a CASHOUT switch 20S corresponding to the CASHOUT button 20, a 1-BET switch 21S corresponding to the 1-BET button 21, and a MAX-BET switch 22S corresponding to the MAX-BET button 22. When a button corresponding to each switch is operated by a player, the switch outputs an input signal to the main CPU 61.

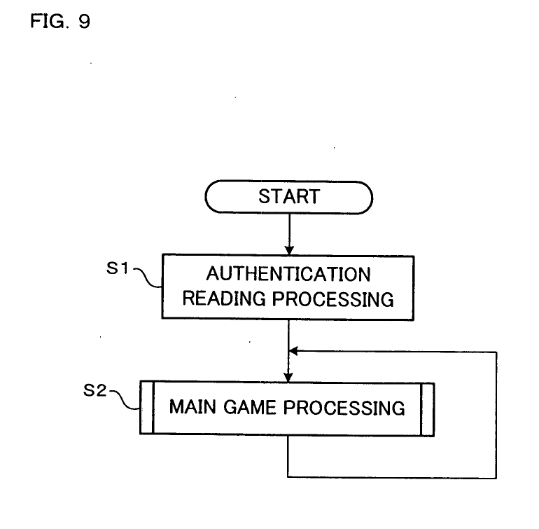

Next, a main control processing program executed in the gaming machine 1 according to the first embodiment will be described in detail with reference to the accompanying drawings. FIG. 9 is a flowchart showing a main control program. Here, it is presupposed that, in the gaming machine 1, the memory card 53 has already been inserted into the card slot 53S of the gaming board 50 and in addition the GAL 54 has already been mounted to the IC socket 54S of the gaming board 50.

First, when a power switch of the power unit 65 is turned on, the power unit 65 is powered up. The mother board 60 and the gaming board 50 are respectively booted up, and an authentication reading processing S1 is executed. In the authentication reading processing, the mother board 60 and the gaming board 50 execute different processings concurrently. To be more specific, in the gaming board 50, the CPU 51 reads out a preliminary authentication program that is stored in a boot ROM 52. In accordance with the preliminary authentication program thus read out, the CPU 51 performs a preliminary authentication for checking and proving that an authentication program is not falsified, before the mother board 60 downloads the authentication program. In the mother board 60, on the other hand, the main CPU 61 executes the BIOS that is stored in the ROM 62, and expands in the RAM 63 compressed data included in the BIOS. Then, the main CPU 61 executes the BIOS thus expanded in the RAM 63. The main CPU 61 also checks and initializes various peripheral units.

Then, the main CPU 61 reads out the authentication program stored in the ROM 55, and performs an authentication for checking and proving that a game program and the like stored in the memory card 53 that is inserted into the card slot 53S are not falsified. When this authentication processing is completed normally, the main CPU 61 writes the game program and the like thus authenticated, into the RAM 63. Subsequently, the main CPU 61 executes a download processing for reading payout rate setting data out of the GAL 54 through the gaming board 50, and the main CPU 61 writes the payout rate setting data thus read out into the RAM 63. After executing the above-described processing, the main CPU 61 completes the authentication reading processing.

Then, in S2, the main CPU 61 sequentially reads out of the RAM 63 the game program and the like that have been authenticated in the authentication reading processing S1, and executes them. The main CPU 61 executes a main game processing. By executing the main game processing, a game is played in the gaming machine 1 according to the first embodiment. The main game processing is executed repeatedly as long as the gaming machine 1 is supplied with power.

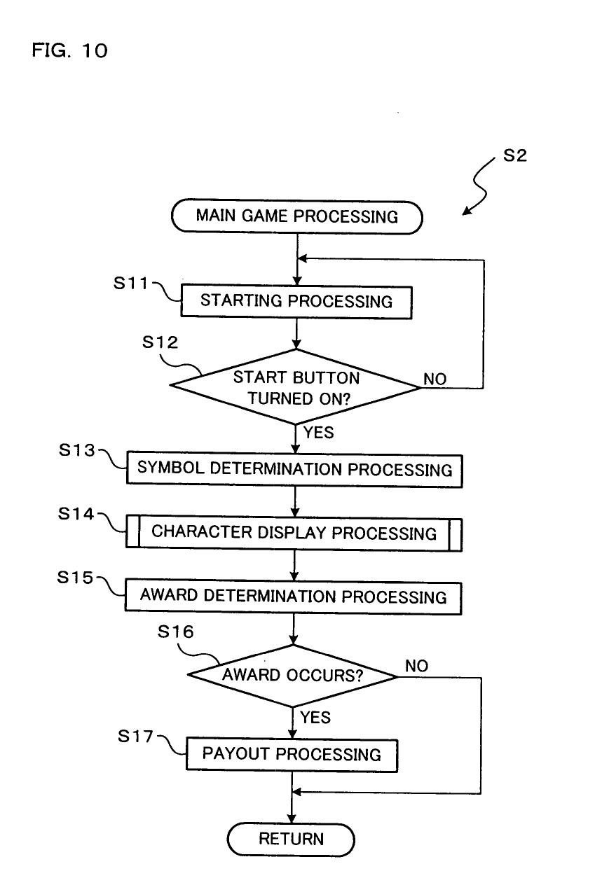

Next, the main game processing S2 will be described with reference to the drawings. FIG. 10 is a flowchart showing a main game processing program according to the first embodiment. Here, programs shown by the flowchart in FIG. 10 are stored in the memory card 53, expanded in the RAM 63 of the gaming machine 1, and executed by the main CPU 61.

As shown in FIG. 10, the main CPU 61 firstly executes a predetermined initialization processing. Then, the main CPU 61 executes a starting processing S11. In the initialization processing, data clearing about an item in a predetermined data field (e.g., a payout number counter) and the like are performed. In the starting processing S11, a player performs a bet operation by inserting a coin or using the 1-BET button 21 or the MAX-BET button 22, so that a coin insertion, a bet value, and the like are set.

Then, in S12, the main CPU 61 determines whether the start button 18 has been inputted or not. Here, whether the start button 18 has been inputted or not is determined based on whether an input signal has been received from the start switch 18S or not. When the start button 18 has not been inputted (S12: NO), the main CPU 61 returns the processing to the starting processing S11 again. At this time, operations such as changing a bet value are permitted. When the start button 18 has been inputted (S12: YES), the main CPU 61 subtracts from a currently-held credit value a bet value that has been set based on an operation of the 1-BET button 21 or the MAX-BET button 22. Then, the main CPU 61 stores the bet value into the RAM 63 as bet data.

Then, in S13, the main CPU 61 executes a symbol determination processing. In the symbol determination processing S13, one symbol 46 is determined by lottery for each of the symbol display areas 31 to 45 of the symbol display section 7, and associated with each of the symbol display areas 31 to 45. To be more specific, the main CPU 61 executes a random number generating program that is included in the lottery program stored in the RAM 63, to thereby sample a random number out of a predetermined random number range. Then, based on the random number thus sampled out and a symbol lottery table, the main CPU 61 determines, among several kinds of symbols, fifteen symbols 46 which will be displayed in the symbol display areas 31 to 45, respectively. After storing the symbols 46 corresponding to the respective symbol display into the RAM 63, the main CPU 61 advances the processing to S14.

In S14, the main CPU 61 executes a character display processing. In the character display processing S14, a character movement amount is determined with respect to every reel display area. The character movement amount specifies a mode of a movement of a weight character image 90, as will be described later. Based on the character movement amount thus determined, the weight character image 90 is moved on a symbol display area basis. In the character display processing S14, animations are displayed in the animation display areas 93 to 97 of the animation display section 92. The character display processing S14 is not described here because a detailed description thereof will be given later with reference to the drawings.

In S15, the main CPU 61 executes an award determination processing. In the award determination processing S15, whether a combination of symbols 46 located on movement paths of weight character images 90 moved by the character display processing S14 is a combination that causes any award or not is determined. More specifically, the main CPU 61 identifies a combination of symbols for the current game by referring to the character movement amount determined with respect to each of the reel display areas 23 to 27 and the symbols 46 associated with the respective symbol display areas 31 to 45. Then, the main CPU 61 determines whether a combination of the identified symbols is a winning combination (see FIG. 6) or not, and determines an award (e.g., an amount of credits paid out) for the current game.

In S16, based on a result of the award determination processing S15, the main CPU 61 determines whether a winning combination is made or not. When it is determined that a winning combination is made (S16: YES), the main CPU 61 advances the processing to S17. When it is determined that a winning combination is not made (S16: NO), the main CPU 61 ends the main game processing S2. Here, in order to continuously start a next game, the processings subsequent to S1 are executed again.

Then, in S17, the main CPU 61 executes a payout processing in which the main CPU 61 gives a player an award based on a result of determination made in the award determination processing. At this time, by pressing the CASHOUT button 20, a payout may be made in the form of coins equivalent to a credit value (one credit is equivalent to one coin) or in the form of a barcoded ticket. As the payout processing S17 ends, the main game processing S2 ends. Here, in order to continuously start a next game, the processings subsequent to S1 are executed again.

Next, a character display processing S14 in the main game processing will be described in detail with reference to the drawings. FIG. 11 is a flowchart showing a character display processing program. In the above-described symbol determination processing S13, symbols 46 are associated with the respective symbol display areas 31 to 45, and image data of the symbols 46 being displayed in the respective symbol display areas 31 to 45 are stored in the first plane of the frame memory. Then, the main CPU 61 starts the character display processing S14.

As shown in FIG. 11, as the character display processing S14 starts, the main CPU 61 firstly executes a character movement amount determination processing S21. In the character movement amount determination processing S21, a character movement amount is determined by lottery with respect to each of the reel display areas 23 to 27. A character movement amount indicates a point at which a weight character image 90 stops its movement in each of the reel display areas 23 to 27. That is, the character movement amount indicates a symbol display area at which the weight character image 90 stops moving over the symbol display areas. In the first embodiment, it indicates the position of a symbol display area as counted from the downmost ones in the reel display area over which the weight character image 90 moving from a lower side passes. To be more specific, the main CPU 61 executes the random number generating program that is included in the lottery program stored in the RAM 63, to thereby sample a random number out of a predetermined random number range. Then, based on a random number thus sampled out and a character movement amount determination table (see FIG. 12), the main CPU 61 determines a character movement amount for each reel display area. After storing character movement amounts for the respective reel display areas 23 to 27 into the RAM 63, the main CPU 61 advances the processing to S22.

Here, the character movement amount determination table will be described in detail with reference to the drawings. FIG. 12 is an explanatory view schematically showing the character movement amount determination table. As described above, in the gaming machine 1 according to the first embodiment, values of “0” to “3” are set as the character movement amount. Accordingly, in the character movement amount determination table, a predetermined random number range is assigned to each of the values “0” to “3”, as shown in FIG. 12. Therefore, a character movement amount for each of the reel display areas 23 to 27 can be determined by referring to a random number range sampled out by the random number generating program and also to the character movement amount determination table.

As described above, a character movement amount determined by the character movement amount determination processing S21 indicates a symbol display area at which a weight character image 90 moving from a lower side stops its movement in each reel display area. That is, the character movement amount “3” means that a weight character image 90 moves to a third lower symbol display area among symbol display areas included in a reel display area. The character movement amount “2” means that a weight character image 90 moves upward to a second lower symbol display area, and the character movement amount “1” means that a weight character image 90 moves upward to a lowermost symbol display area. The character movement amount “0” means that a weight character image 90 stops its movement at the outside of the symbol display section 7 without reaching a lowermost symbol display area of the reel display area.

Here, a description will be given by means of a specific example of FIG. 4. When a character movement amount for the reel display area 25 is “3”, a weight character image 90 moves upward to the symbol display area 37. When a character movement amount for the reel display area 25 is “2”, a weight character image 90 moves upward to the symbol display area 38. When a character movement amount for the reel display area 25 is “1”, a weight character image 90 moves upward to the symbol display area 39. When a character movement amount for the reel display area 25 is “0”, a weight character image 90 does not reaches the symbol display area 39 located lowermost in the reel display area 25 and stops its movement at a position below the symbol display area 39 and above the animation display area 95.

As character movement amounts for the respective reel display areas 23 to 27 are determined by the character movement amount determination processing S21, the main CPU 61 initializes a value T of a character counter stored in the RAM 63 and sets the value T to “1” which is an initial value (S22). After setting the value T of the character counter to “1”, the main CPU 61 advances the processing to S23. Here, the value T of the character counter is a value indicating an animation display area and a reel display area where a weight character image 90 moves. In the gaming machine 1 according to this embodiment, a weight character image 90 moves firstly in the leftmost animation display area 93 and reel display area 23. Then, a movement of a weight character image 90 occurs in the righthand animation display areas 94 to 97 and reel display areas 24 to 27 sequentially in this order. That is, when the value T is “1”, a movement of the weight character image 90 occurs in the reel display area 23 and the animation display area 93. When the value T is “5”, a movement of the weight character image 90 occurs in the reel display area 27 and the animation display area 97. That is, a value of the character counter corresponds to a position of a reel display area and an animation display area as counted from the leftmost ones in the symbol display section 7 and the animation display section 92.

In S23, the main CPU 61 starts displaying an animation in the animation display area that corresponds to the value T of the character counter. In a case where the character counter is “1” for example, the corresponding animation display area 93 is enlarged. An image showing that “a person character swings up a hammer toward one end of a seesaw so that a weight character image 90 placed on the other end of the seesaw is ready to launch up” is displayed in the animation display area 93. Then, an animation showing that “a person character swings down a hammer so that a weight character image 90 is launching up” starts to be displayed in the animation display area 93. The main CPU 61 advances the processing to S24 at a point of time when the animation starts to be displayed in the animation display area corresponding to the value of the character counter.

In S24, the main CPU 61 reads out the value T of the character counter, and reads out of the RAM 63 a character movement amount for the reel display area and the animation display area that correspond to the value T of the character counter. Based on the character movement amount thus read out, the main CPU 61 moves the weight character image 90 (S25).

A specific description will be given to the movement of the weight character image 90 in these steps S23 to S25 (see FIGS. 1 and 2). In S23, as described above, the animation showing that “a person character swings down a hammer so that a weight character image 90 is launching up” starts to be displayed in an animation display area that corresponds to a value of the character counter. Thus, in the animation display area, the person character swings down the hammer, so that the weight character image 90 is moved upward. Here, by a time when the weight character image 90 reaches an upper edge of this animation display area, a character movement amount for this weight character image 90 is read out by the processing performed in S24. Then, at a time when the weight character image 90 reaches the upper edge of the animation display area, that is, at a time when the animation displayed in the animation display area ends, the weight character image 90 is, in accordance with the character movement amount, moved upward through a reel display area that corresponds to the value of the character counter. Here, at a time when the weight character image 90 reaches a certain symbol display area, a background color of this symbol display area is changed from “black” to “white”. As a movement of the weight character image 90 in the reel display area ends, the main CPU 61 advances the processing to S26.

In S26, the main CPU 61 refers to a value T of the character counter formed in the RAM 63, and determines whether the value T is “5” or not. More specifically, in S26, the main CPU 61 determines whether the movement of the weight character image 90 is completed in all the symbol display areas 23 to 27 and all the animation display areas 92 to 97 included in the symbol display section 7 and the animation display section 92, respectively. When the movement of the weight character image 90 is completed in all the reel display areas 23 to 27 (S26: YES), the main CPU 61 ends the character display processing S14 and shifts the processing to the main game processing program. When a value T of the character counter is not “5” (S26: NO), the main CPU 61 adds “1” to the value T of the character counter (S27). After adding “1” to the value T of the character counter, the main CPU 61 returns the processing to S23. As the processing is returned to S23, a movement of the weight character image 90 occurs in a reel display area and an animation display area located right next to the reel display area in which the last movement of the weight character image 90 occurred.

### Second Embodiment

Next, a second embodiment of the present invention will be described in detail with reference to the accompanying drawings. In the second embodiment, the present invention is applied to a gaming machine 100 that adopts a mechanical reel. In the second embodiment, the same members and the same devices as those of the first embodiment will be denoted by the same reference numerals, and the same constructions as those of the first embodiment will not be described in detail.

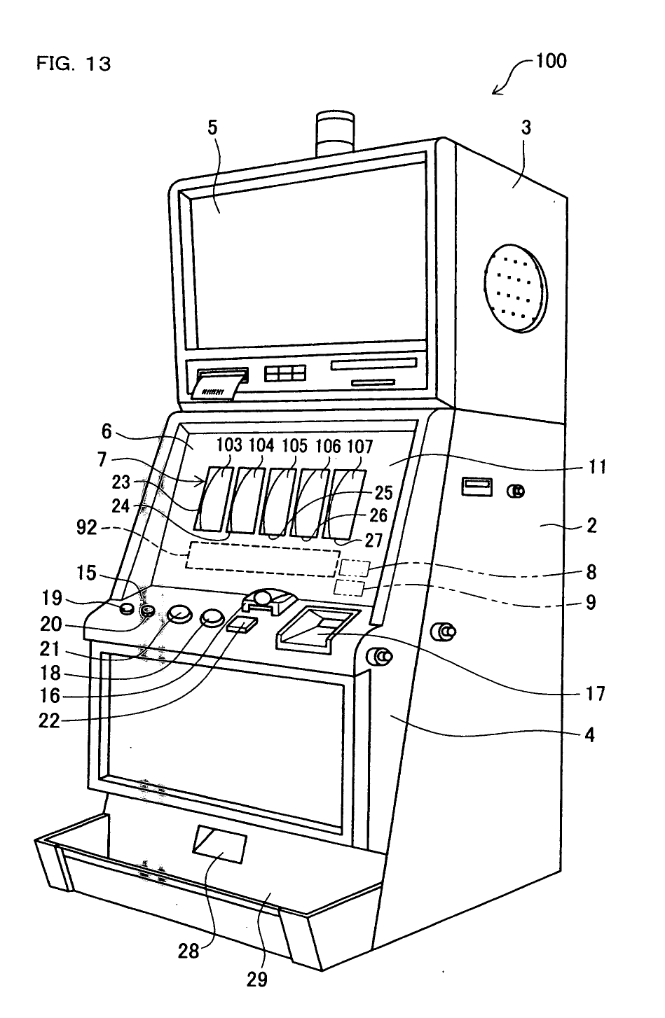

First, a general construction of the gaming machine 100 according to the second embodiment will be described with reference to the accompanying drawings. FIG. 13 is a perspective view showing an appearance of the gaming machine 100 according to the second embodiment. As shown in FIG. 13, a basic construction of the gaming machine 100 according to the second embodiment is the same as that of the gaming machine 1 according to the first embodiment. Here, unlike the so-called video gaming machine according to the first embodiment, the gaming machine 100 according to the second embodiment adopts a mechanical reel. Thus, the gaming machine 100 differs from the gaming machine 1 only in the mechanical reel. Accordingly, a detailed description will be given only to a construction of the mechanical reel.

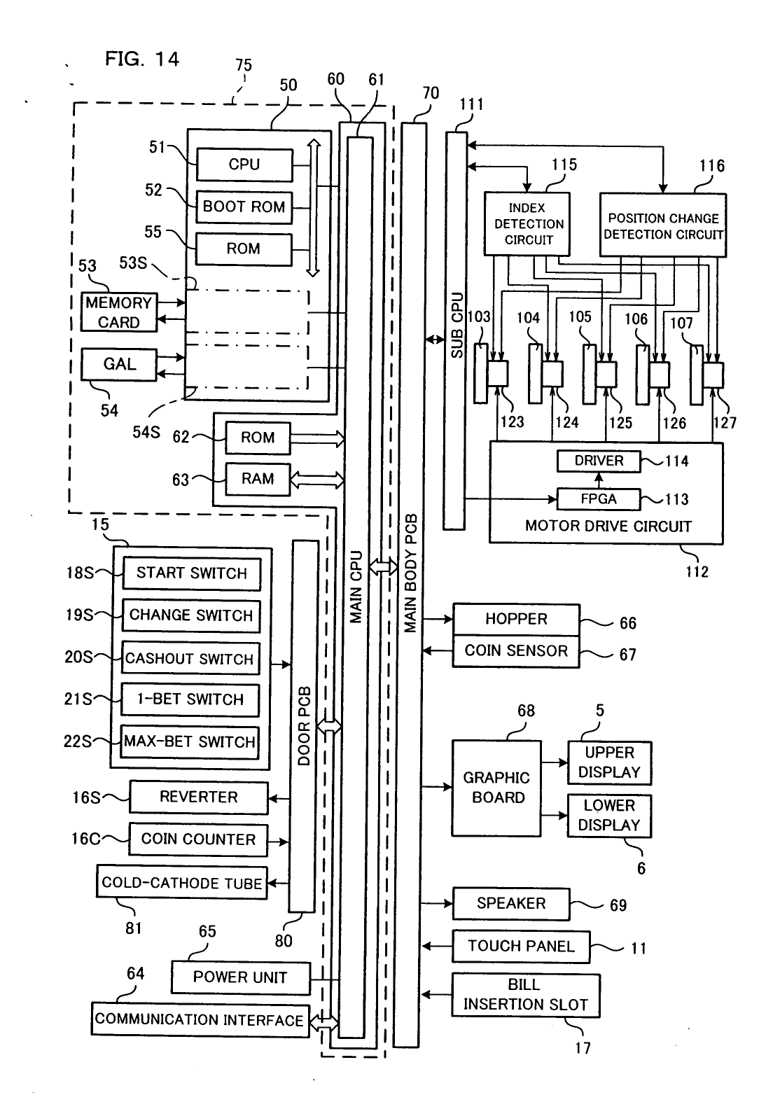

In the gaming machine 100, as shown in FIG. 13, a lower display 6 is provided on a front face of a main door 4. Here, the lower display 6 of the gaming machine 100 is formed of a transparent liquid crystal display. Reel display areas 23 to 27 are provided in a central portion of the lower display 6 so that an inside of a cabinet 2 of the gaming machine 100 can be seen. Inside the cabinet 2, mechanical reels 103 to 107 are rotatably disposed behind the reel display areas 23 to 27. Stepping motors 123 to 127 are provided for the mechanical reels 103 to 107, respectively. By controlling driving of the stepping motors 123 to 127, rotation of the mechanical reels 103 to 107 is controlled (see FIG. 14). First to fifth columns of symbols as in the first embodiment are shown on peripheral surfaces of the mechanical reels 103 to 107, respectively. Therefore, the columns of symbols shown on the peripheral surfaces of the mechanical reels 103 to 107 can be seen through the reel display areas 23 to 27.

In the gaming machine 100, like in the gaming machine 1, three symbols 46 are disposed in one reel display area. That is, each of the reel display areas 23 to 27 has three symbol display areas. As shown in FIG. 13, in the gaming machine 100 as well, a symbol display section 7 is made up of five reel display areas (reel display areas 23 to 27). Thus, the symbol display section 7 of the gaming machine 100 also includes symbol display areas 31 to 45. The symbol display areas 31 to 45 are arranged in the symbol display section 7, in a matrix with five columns and three rows.

Next, a control system of the gaming machine 100 according to the second embodiment will be described in detail with reference to the drawings. FIG. 14 is a block diagram showing a control system of the gaming machine 100 according to the second embodiment. As described above, the gaming machine 100 according to the second embodiment differs from the gaming machine 1 according to the first embodiment only in mechanical reels 103 to 107. Therefore, a construction regarding the mechanical reels 103 to 107 will be described in detail. The other constructions are the same as the above-described ones of the gaming machine 1 according to the first embodiment, and repeated description thereof will be omitted here.

As shown in FIG. 14, a sub CPU 111 as well as a hopper 66, a coin sensor 67, a graphic board 68, a speaker 69, a touch panel 11, and a bill insertion slot 17 is connected to a main body PCB 70. The sub CPU 111 controls rotation and stopping of the mechanical reels 103 to 107. A motor drive circuit 112 including an FPGA (Field Programmable Gate Array) 113 and a driver 114 is connected to the sub CPU 111. The FPGA 113 is an electronic circuit such as a programmable LSI, and functions as a control circuit for the stepping motor's 123 to 127. The driver 114 functions as an amplifier circuit for a pulse which will be inputted to the stepping motors 123 to 127. The stepping motors 123 to 127, which are of 1-2 phase excitation type, are connected to the motor drive circuit 112. The stepping motors 123 to 127 rotate the respective mechanical reels 103 to 107.

In addition, an index detection circuit 115 and a position change detection circuit 116 are connected to the sub CPU 111. The index detection circuit 115 detects a position, e.g. a reference point, of the rotating mechanical reels 103 to 107. The index detection circuit 115 also detects out-of--step of the mechanical reels 103 to 107. The position change detection circuit 116 detects a change of a stopping position of the mechanical reels 103 to 107 after rotation of the mechanical reels 103 to 107 is stopped. For example, in a case where a winning combination of symbols is actually not made but nevertheless a player forcibly changes a stopping position so as to make a winning combination of symbols, the position change detection circuit 116 detects a change of a stopping position of the mechanical reels 103 to 107.

In the gaming machine 100 having a construction shown in FIGS. 13 and 14, like in the first embodiment, a main control program (FIG. 9), a main game processing program (FIG. 10), and a character display processing (FIG. 11) are executed. Basic contents of these programs are the same as in the first embodiment, and therefore detailed descriptions of these programs will be omitted. In the first embodiment, image data stored in the first and second planes of the frame memory are composed, and image data thus composed are displayed on the lower display 6. In the second embodiment, however, only image data concerning weight characters 90 (which mean image data stored in the second plane) have to be displayed on the lower display 6. Therefore, composition of image data is not needed.

As thus far described above, in the gaming machine 1 of the present invention, upon start of a game, symbols 46 are placed in fifteen symbol display areas 31 to 45 arranged in a 3-times-5 matrix. Then, in the character display processing S14, movements of the weight character images 90 based on the character movement amounts occur in the respective reel display areas 23 to 27 each made up of a column of three symbol display areas. The movements originate from animations displayed in the animation display areas 93 to 97 which are formed below the symbol display section 7. In each reel display area, the weight character image 90 is moved from below to above. A movement distance of the weight character image 90 is determined by a character movement amount. The character movement amount is on a unit basis of a symbol display area that constitutes the reel display area. When the weight character image 90 reaches a certain symbol display area, a background color of this symbol display area is changed from “black” to “white”. After a weight character image 90 is moved based on a character movement amount in each of the reel display areas 23 to 27, an award given to a player is determined based on a combination of symbols. The combination is made up of symbols 46 that are located on movement paths of the weight character images 90 in the symbol display section 7.

With this construction, at a start of a game, a player cannot know which ones of fifteen symbols 46 arranged in the symbol display section 7 will be included in an award-giving combination of symbols. This makes a player feel an increased sense of tension for an award given in the gaming machine.

Moreover, with respect to each of the reel display areas 23 to 27, a mode of moving a weight character image 90 is determined by lottery to be one of character movement amounts “0” to “3”. That is, symbols 46 which are decisive for an award are randomly determined on a reel display area basis. This mode is not a simple one such as a conventional activated pay line. Accordingly, it is difficult to guess in which symbol display areas symbols 46 decisive for an award will be displayed. This can enhance player's expectation.

Further, a symbol display area in which a symbol 46 decisive for an award is displayed differs in background color from a symbol display area in which a symbol 46 non-decisive for an award is displayed. This allows a player to easily understand, based on a display mode of the symbol display section 7, a combination of symbols decisive for an award. In addition, such a difference in background color of the symbol display areas gives a player a clear understanding that an award is determined independently of an activated pay line or the like, which is a quite different mode from modes of the conventional gaming machines.

The present invention is not limited to the above-described embodiments. It is evident that various improvements and modification can be made without departing from the spirit and scope of the present invention. For example, although in the above-described embodiment symbols placed in the respective symbol display areas are determined by the symbol determination processing S13, this is not limitative. It may be possible that, for example, symbols of the same kind are always fixedly placed in the respective symbol display areas. In addition, in the above-described embodiment, symbols placed in the respective symbol display areas are determined based on the column of symbols corresponding to the respective reel display areas 23 to 27, that is, they are determined on a reel display area basis. However, it may also be possible to determine symbols on a symbol display area basis by determining one symbol among several symbols for each of the symbol display areas 31 to 45.

In the above-described embodiment, the symbol display section 7 is made up of symbol display areas that are arranged in a 3-times-5 matrix. However, this is not limitative, and various modes are acceptable. For example, the symbol display section 7 may be made up of symbol display areas that are arranged in a honeycomb-like form or in a pyramid-like shape.

In addition, in the above-described embodiment, a movement of the weight character image 90 occurs in all the reel display areas 23 to 27. However, it may also be possible that a movement of the weight character image 90 occurs in a part of the reel display areas. Besides, a direction of movement of the weight character image 90 in the symbol display section 7 may not necessarily be a longitudinal direction along the reel display areas 23 to 27. For example, the weight character image 90 may be moved from left to right across the symbol display section 7.

In the above-described embodiment, a character movement amount is determined among “0” to “3”, and the weight character image 90 is moved based on the determined character movement amount. This determination may be done taking various game conditions (such as a bet value, accomplishment of a predetermined combination of symbols, and the like) into consideration. For example, it may be possible to use a character movement amount determination table that assigns a wider range of random numbers to character movement amounts “2” and “3” among the character movement amounts “0” to “3”, on a condition that a maximum bet is made.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A gaming machine comprising:
a display that displays thereon a symbol display area in which one of a plurality of symbols is arranged, and a symbol display frame made up of a plurality of symbol display areas; and
a game controller,
wherein, when executing a game, the game controller performs:
displaying, at an outside of the symbol display frame, a character that moves on a movement path having a symbol display area as a unit basis thereof;
moving the character displayed at the outside of the symbol display frame, along the movement path over the symbol display areas; and
determining an award given to a player based on a combination of symbols that are located on the movement path of the moving character.

2. The gaming machine according to claim 1, wherein the game controller determines a movement path of the character based on a movement end point at which a movement of the character ends and, when moving the character, moves the character to the movement end point along the movement path of the character.

3. The gaming machine according to claim 1, wherein:
the display displays thereon a symbol display frame made up of a plurality of symbol display areas that are arranged in a matrix;
the game controller performs displaying, at an outside of the symbol display frame, characters each corresponding to each row or column of symbol display areas included in the symbol display frame; and
the game controller performs moving each of the characters within the symbol display frame, on a linear movement path extending along a corresponding row or column.

4. A gaming machine comprising:
a display that displays thereon a symbol display area in which one of a plurality of symbols is arranged, and a symbol display frame made up of a plurality of symbol display areas arranged in a matrix; and
a game controller,
wherein, when executing a game, the game controller performs:
displaying, at an outside of the symbol display frame, characters each corresponding to each row or column of symbol display areas included in the symbol display frame and each moving along the corresponding row or column on a symbol display area basis within the symbol display frame;
determining, for every row or column of symbol display areas, a movement end point at which a movement of the character along the row or column ends;
moving each of the characters displayed at the outside of the symbol display frame, over the symbol display areas toward the movement end point, in accordance with a linear movement path that extends along the corresponding row or column of symbol display areas; and
determining an award given to a player based on a combination of symbols that are located on the movement paths of the moving characters.

5. The gaming machine according to any one of claim 1, wherein, when executing a game, the game controller performs rearranging symbols in the symbol display frame.

6. A playing method for a gaming machine comprising a symbol display frame that is displayed on a display and made up of a plurality of symbol display areas in each of which one of a plurality of symbols is arranged,
wherein, when executing a game, a game controller performs:
displaying, at an outside of the symbol display frame, a character that moves on a movement path having a symbol display area as a unit basis thereof,
moving the character displayed at the outside of the symbol display frame, along the movement path; and
determining an award given to a player based on a combination of symbols that are located on the movement path of the moving character.

7. The playing method according to claim 6, wherein:
the game controller further performs determining a movement path of the character based on a movement end point at which a movement of the character ends; and
when the character is moved, the character is moved to the movement end point along the movement path of the character.

8. The playing method according to claim 6, wherein:
when displaying the character at the outside of the symbol display frame made up of the plurality of symbol display areas that are arranged in a matrix, the game controller displays characters each corresponding to each row or column of symbol display areas included in the symbol display frame; and
when moving the characters, the game controller moves each of the characters on a linear movement path extending along a corresponding row or column.

9. A playing method for a gaming machine comprising a plurality of symbol display areas in each of which one of a plurality of symbols is arranged, and a symbol display frame that is displayed on a display and made up of a plurality of symbol display areas arranged in a matrix, wherein, when executing a game, a game controller performs:
displaying, at an outside of the symbol display frame, characters each corresponding to each row or column of symbol display areas included in the symbol display frame and each moving along the corresponding row or column on a symbol display area basis within the symbol display frame;
determining, for every row or column of symbol display areas, a movement end point at which a movement of the character along the row or column ends;
moving each of the characters displayed at the outside of the symbol display frame, over the symbol display areas toward the movement end point, in accordance with a linear movement path that extends along the corresponding row or column of symbol display areas; and
determining an award given to a player based on a combination of symbols that are located on the movement paths of the moving characters.

10. The playing method according to claim 6, wherein, when executing a game, the game controller performs rearranging symbols in the symbol display frame.

11. The gaming machine according to any one of claim 2, wherein, when executing a game, the game controller performs rearranging symbols in the symbol display frame.

12. The gaming machine according to any one of claim 3, wherein, when executing a game, the game controller performs rearranging symbols in the symbol display frame.

13. The gaming machine according to any one of claim 4, wherein, when executing a game, the game controller performs rearranging symbols in the symbol display frame.

14. The playing method according to claim 7, wherein, when executing a game, the game controller performs rearranging symbols in the symbol display frame.

15. The playing method according to claim 8, wherein, when executing a game, the game controller performs rearranging symbols in the symbol display frame.

16. The playing method according to claim 9, wherein, when executing a game, the game controller performs rearranging symbols in the symbol display frame.
